(19) United States
(12) Patent Application Publication
(10) Pub. No.: US 2012/0230895 A1
(43) Pub. Date: Sep. 13, 2012

(54) SOUR NATURAL GAS SPARGER

(76) Inventor: Sertsai A. SEYOUM, Calgary (CA)

(21) Appl. No.: 13/043,018

(22) Filed: Mar. 8, 2011

(51) Int. Cl. B01D 53/52; B01J 19/00; B01D 53/62

(52) U.S. Cl. 423/220; 422/129

(57) ABSTRACT

An apparatus and method is provided for treating sour natural gas. The apparatus comprises a sparger for use in a high pressure and associated or non-associated sour natural gas environments. The sparger is used to disperse sour natural gas inside a sweeting tower/sulphide treatment vessel to facilitate an efficient transfer of hydrogen sulphide or carbon dioxide from the sour natural gas to a sweeting chemical inside the sulphide treatment vessel. A portion of the sparger exposed to the sulphide treatment environment is protected with a corrosion resistant layer/coating. The corrosion resistant layer protects the substrate metal of the sparger from corrosive environment of the sour natural gas inside or outside of the sparger. Corrosion resistant layer material may be selected so as to prevent the substrate metal from corrosion and suphide cracking.

### FIELD OF THE INVENTION

The present invention relates to sparger and, in particular, sparger for use in sour natural gas sweetening tower/sulphide treatment vessel for sour high pressure services in oil and gas industry.

### BACKGROUND OF THE INVENTION

The natural gas used by consumers is composed almost entirely of methane. However, natural gas found at the wellhead, although still composed primarily of methane, is by no means as pure. Raw natural gas comes from three types of wells: oil wells, gas wells, and condensate wells. Natural gas that comes from oil wells is typically termed ‘associated gas’. This gas can exist separate from oil in the formation (free gas), or dissolved in the crude oil (dissolved gas). Natural gas from gas and condensate wells, in which there is little or no crude oil, is termed ‘non-associated gas’. Whatever the source of the natural gas, once separated from crude oil (if present) it commonly exists in mixtures with other hydrocarbons; principally ethane, propane, butane, and pentanes. In addition, raw natural gas contains water vapor, hydrogen sulphide (H₂S), carbon dioxide, helium, nitrogen, and other compounds.

Hydrogen sulphide, carbon dioxide, mercaptans and other contaminants are often found in natural gas streams. H₂S is a highly toxic gas that is corrosive to carbon steels. CO₂ is also corrosive to equipment and reduces the Btu value of gas. Gas sulphide treatment processes remove these contaminants so the gas is suitable for transportation and use.

Many companies design and manufacture a variety of gas sulphide treatment systems, mainly batch or continuous systems. A number of solvents will remove the contaminants by chemical reaction. Custom and standard designs are available to meet any gas sulphide treatment challenge. The said invention mainly can be deployed in a batch sulphide treatment process system. The sparger can and will maximize the contact efficiency of the process between the natural gas and solvent chemical.

A difficulty without providing for natural gas sparging is that the gas may not make adequate contact with a sulphide treatment chemical to remove the hydrogen sulphide or carbon dioxide. To avoid big bubbles from forming a sparger is used to disperse and atomize the natural gas entering the tower or a sulphide treatment vessel. The sparger can typically be constructed of carbon steel, stainless steel alloys or austentic stainless steel. Unfortunately, existing spargers in the market today are design for oxygen sparging, which is not suitable for this service at very low pressures and have a short service life owing to the fact that the sparger is subject to corrosion in the environment of a natural sulphide treatment process.

There does not appear to be a sparger that can perform suitably for sour service, and there remains a need for a sparger capable of operating under high pressure and sour/corrosive conditions.

### SUMMARY OF THE INVENTION

The present invention provides a commercial steel sparger for use in high pressure and sour environments. The steel sparger is formed from standard commercial steel metal substrate. The outer surface of the metal exposed to the sulphide treatment environment is protected with a corrosion resistant layer/coating. The corrosion resistant layer protects the substrate material from corrosive environment of the sour natural gas and inside or outside of the sparger. The corrosion resistant layer protects the substrate material from the sour environment of the sulphide treatment vessel. The substrate material and corrosion resistant material may be selected so as to provide for sufficient protection to prevent the metal from corrosion and sulphide stress cracking that is common in these environments.

In one aspect, a sparger is provided for use in a process within a sulphide treatment vessel/tower having an inlet nozzle. The sparger includes a tube having middle end for fluid communication with the sulphide treatment tower/vessel and first end for coupling to a sour natural gas supply from wellhead or otherwise. The sparger also has a flange connected to and extending outwardly from the tube for sealing the sparger to the inlet nozzle. The sparger ¼″ flange would be trapped flange mounted between the inlet piping flange and vessel inlet nozzle. Suitable gaskets inserted on each end of the flange and bolts running through the flange to secure the sparger to an inlet of a sulphide treatment vessel/tower.

In another aspect a sparger is provided for dispersing a sour natural gas into a tower/sulphide treatment vessel through an inlet nozzle, the sulphide treatment vessel being employed in a process. The sparger includes a metal tube and a corrosion resistant layer/coating on a surface of the tube, the corrosion resistant layer being applied on the surface to prevent the metal tube from exposure to the sour natural gas and the process.

In another aspect an apparatus is provided for treating sour natural gas. The apparatus comprises a sulphide treatment vessel comprising a reactive fluid therein. A sparger comprises a perforated tube. At least a portion of the tube is corrosive resistant. The sparger is in fluid communication with the sulphide treatment vessel and a sour natural gas supply for dispersing the sour natural gas into the reactive fluid.

In yet another aspect a method for removing hydrogen sulphide or carbon dioxide from sour natural gas is provided. The method comprises inserting a corrosive resistant sparger into a sulphide treatment vessel having a reactive fluid therein. A portion of the sparger is in contact with the reactive fluid. Sour natural gas is delivered to the sparger through a process piping. Sour natural gas is dispersed into the reactive fluid through the sparger for maximizing contact between the sour natural gas and the reactive fluid for removing hydrogen sulphide or carbon dioxide from the sour natural gas.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings, which show an embodiment of the present invention, and in which:

FIG. 1A shows a top/bottom view of the sparger;

FIG. 1B shows a cross-sectional view of the tube of the sparger of FIG. 1A along lines B-B;

FIG. 2 shows a side view of the sparger;

FIG. 3 shows a cross-sectional view of the sparger inserted into a sulphide treatment vessel through inlet nozzles;

FIG. 4 is an expected performance curve of gas flow vs. pressure; and

FIG. 5 is an expected performance curve of tower diameter vs. gas flow at maximum bubble rate rise.

Similar reference numerals are used in different figures to denote similar components.

### DETAILED DESCRIPTION OF THE PREFERRED EMBODIMENTS

The following description of one or more specific embodiments of the invention does limit the implementation of the invention to associated or non-associated sour natural gas spargers. Other gases or liquids may be used as reactive chemicals. It will be also understood that the invention is limited to spargers for natural gas and may be embodied in spargers used to disperse other oil field gases.

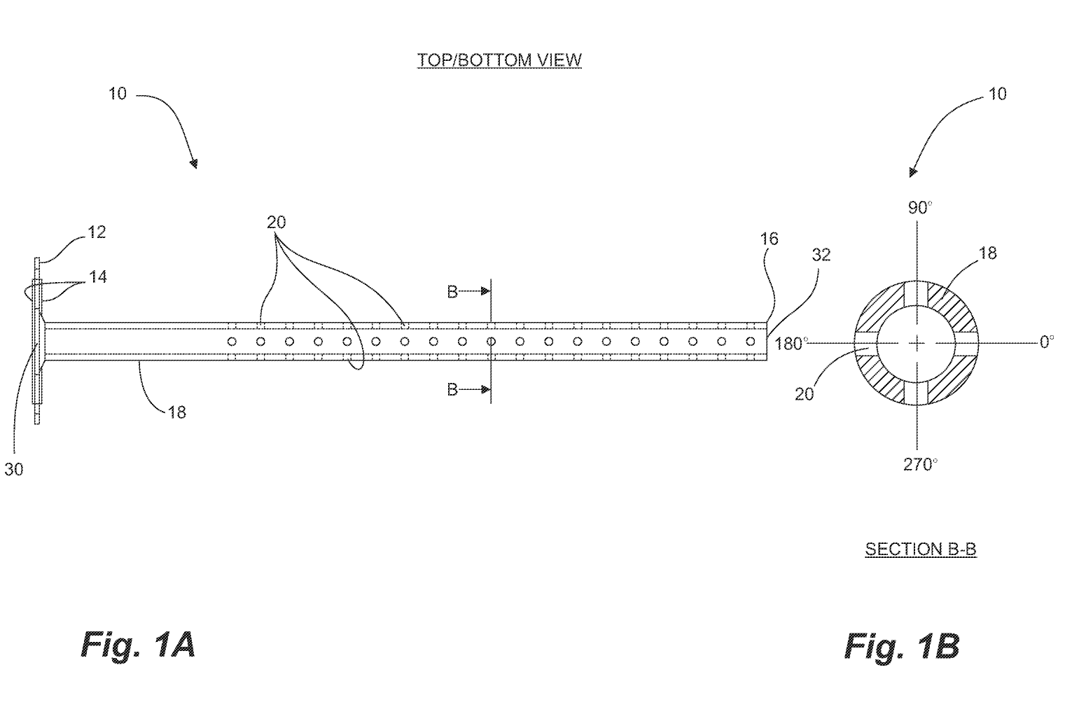

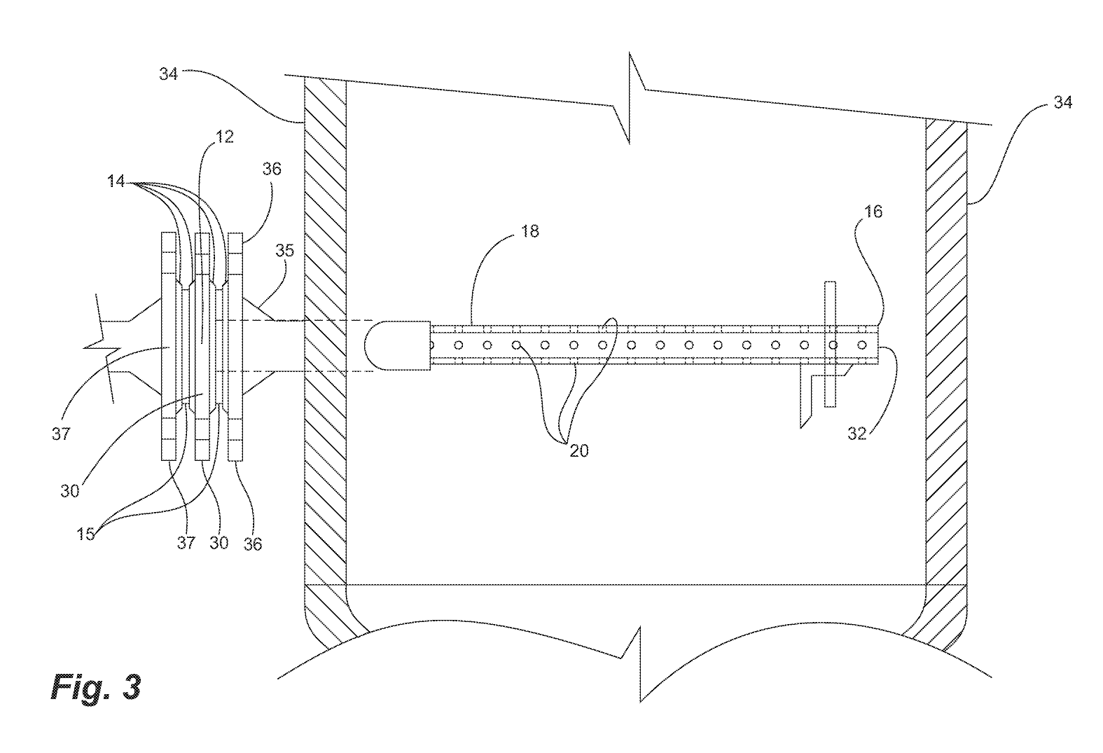

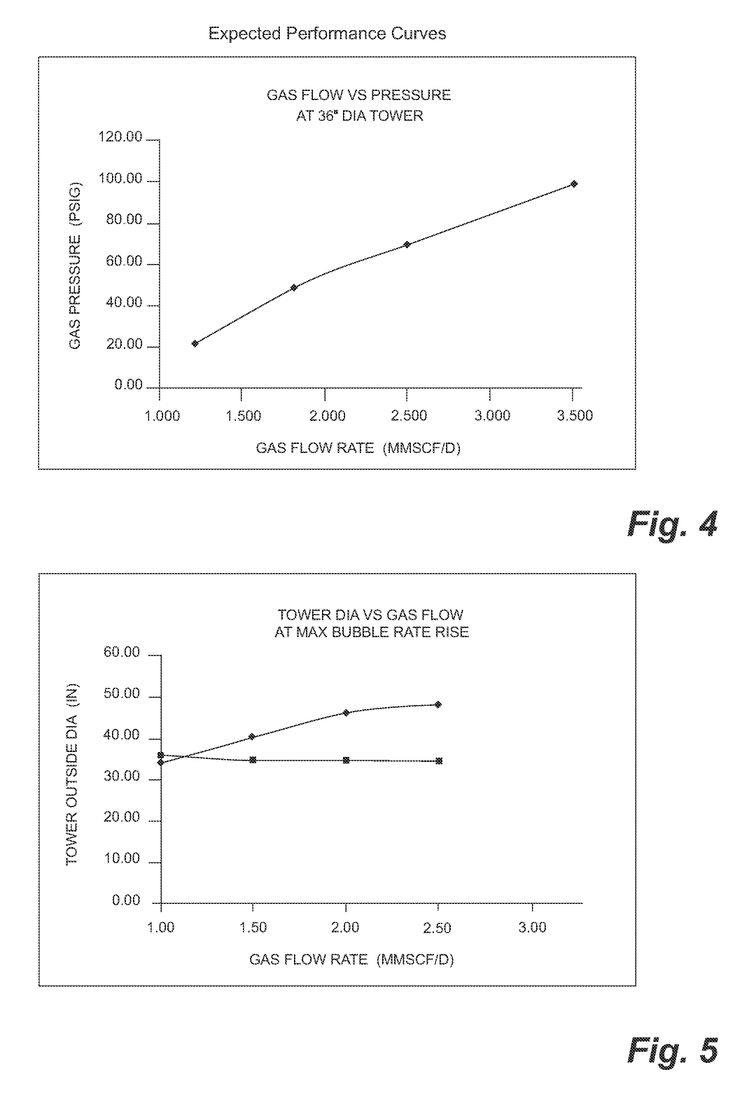

Reference is first made to FIG. 1, which shows a top/bottom view of a sparger 10 inserted (See FIG. 3) into a sulphide treatment vessel through a sulphide treatment vessel inlet nozzle 36. The sparger 10 includes a tube 18 which is perforated 20 for delivery of gas to a vessel or sulphide treatment vessel 34. The gas, such as sour natural gas, from a well head or otherwise (not shown) is delivered to the interior of the sulphide treatment vessel through the sulphide treatment vessel inlet nozzle 35. The sparger 10 includes an outlet end 16 disposed within the interior of the sulphide treatment vessel and an inlet end 12 disposed outside the sulphide treatment vessel inlet nozzle 35.

During a sulphide treatment process, at least a 50% of vessel of the interior of the sulphide treatment vessel contains a reactive chemical fluid. The interior of the sulphide treatment vessel may include a mist pad vapour zone mixture of natural gas and reactive chemical above the reactive chemical fluid. In some embodiments, the reactive chemical may include 1,3,5-Triazine-1,3,5(2H,4H,6H)-triethanol, ethylene glycol, methanol, ethanolamine and other corrosive media.

The sparger 10 is formed from a commercial steel tube 18 having at least a part of its surface coated with a corrosion resistant layer. The sparger 10 is joined with the inlet flange 30 at the inlet end 12 of the sparger 10.

The end of the sulphide treatment vessel inlet nozzle features a mounting flange 36. The sparger inlet flange 30 includes a nozzle raised face ring 14 formed from the same or similar material as inlet nozzle flange 36. The ring 14 of the inlet flange 30 is applied to the face of the nozzle raised faced ring 14 of the, and towards the, mounting flange 36. The ring 14 may be machined to provide for a gasket seat 15 in order to seal the sparger 10 to the mounting flange 36 to secure the sparger 10 to the sulphide treatment vessel inlet nozzle 35 and seal the raised faced ring 14 of the inlet flange 30 against the mounting flange 36.

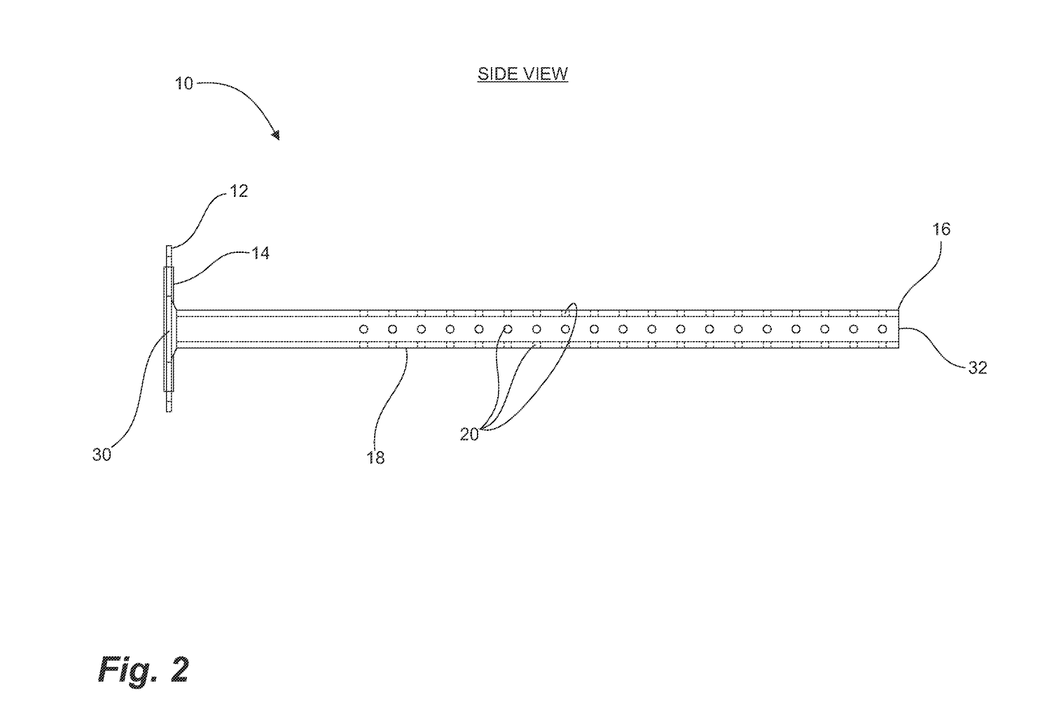

Reference is now made to FIGS. 1 and 2, which show the end cap 32 and inlet flange 30 joined to the sparger 10 by way of strength and seal welds. The strength welds are created in accordance with applicable codes and standard welding practices.

The sparger 10 is inserted in a sour natural gas sulphide treatment vessel nozzle 36 and the vessel shell 34. The sparger inlet flange 30 is trap mounted between inlet flange 36 and process piping flange 37 that would be connected to inlet flange 36.

Reference is now made to FIG. 3, which shows a general method of mounting the sparger 10 inside a natural gas sulphide treatment vessel 34.

The corrosion resistant tube is formed from a metal selected from materials which do not crack under sulphide stress. The metal comprises a material selected from the list consisting of commercial steel, SA-516 70, 304L SS, 347 SS, 430 SS, Nickel, Hastelloy C276, C22 and X, and Alloy 20. Alternatively, the metal is selected from the group consisting of stainless steel, austenitic stainless steel, duplex stainless steel and super-duplex stainless steel.

The corrosion resistant tube 18 comprises at least one layer of corrosion resistant material. The thickness of the corrosion resistant layer is 76 μm-102 μm. The corrosion resistant material is DEVOE Devchem 253™ or International TLA-350 epoxy system. Preferably, the corrosion layer is formed by applying three layers of DEVOE Devchem 253™ or International TLA-350 epoxy at 76 μm-102 μm DFT per coat at said ends.

The minimum thickness of the tube 18 may be determined from classical stress analysis, such that the primary membrane stress (circumferential or hoop stress) is less than 70% of the yield stress of the selected material or the allowable working stress permitted by code for the selected material. The minimum required thickness of the tube can be determined from classical stress analysis or finite element method such that the selected material or 1.5 times the allowable working stress permitted by code for the selected material. The minimum required weld reinforcement size, as measured across the throat of the fillet, may be determined by classical stress analysis such that the primary, plus bending, plus localized secondary stresses do not exceed the ultimate tensile stress of the selected material or three times the allowable working stress permitted by Code for the selected material.

Although the foregoing figures and description depict an embodiment wherein the sparger is inserted through a nozzle in the underside of a sulphide treatment vessel directly into the sulphide treatment fluid, it will be appreciated that the sparger may be inserted through a nozzle in the side, top or other portion of the vessel and may be placed in the liquid zone of the vessel.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention for which an exclusive property or privilege is claimed are defined as follows:

1. An apparatus for treating sour natural gas comprising:
a sulphide treatment vessel comprising a reactive fluid therein;
a sparger comprising a perforated tube a portion of which is corrosive resistant;
the sparger in fluid communication with the sulphide treatment vessel and a sour natural gas supply for dispersing the sour natural gas into the reactive fluid.

2. The apparatus of claim 1, wherein the portion of the tube in contact with the reactive fluid is corrosive resistant.

3. The apparatus of claim 1, wherein the portion of the tube disposed inside the treatment vessel is corrosive resistant.

4. The apparatus of claim 1, wherein the reactive fluid is an alcohol based reactive fluid.

5. The apparatus of claim 1, wherein the reactive fluid includes 1,3,5-Triazine-1,3,5(2H,4H,6H)-triethanol or ethylene glycol or methanol or ethanolamine.

6. The apparatus of claim 1, wherein the sulphide treatment vessel comprises an inlet nozzle provided with an inlet flange and a process piping connected to the sour natural gas supply for delivering the sour natural gas to the sparger.

7. The apparatus of claim 6, wherein the sparger is inserted into the sulphide treatment vessel through the inlet nozzle and further comprises a sparger flange at an end thereof facing and for mounting to the inlet nozzle flange.

8. The apparatus of claim 7, wherein the sparger is secured to the sulphide treatment vessel by trap mounting the sparger flange between the inlet nozzle flange and a process piping flange of the process piping.

9. A method for removing hydrogen sulphide or carbon dioxide from sour natural gas comprising:
inserting a corrosive resistant sparger into a sulphide treatment vessel having a reactive fluid therein, a portion of the sparger in contact with the reactive fluid;
delivering sour natural gas to the sparger through a process piping;
dispersing sour natural gas into the reactive fluid through the sparger for maximizing contact between the sour natural gas and the reactive fluid for removing hydrogen sulphide or carbon dioxide from the sour natural gas.

10. The method of claim 9, wherein the sparger is inserted into the sulphide treatment vessel through an inlet nozzle provided in the treatment vessel.

11. The method of claim 9, wherein the sparger is secured to the sulphide treatment vessel by trap mounting a flange formed at one end of the sparger between an inlet nozzle flange and a process piping flange.

12. The apparatus of claim 1, wherein the corrosion resistant tube is formed from a metal selected from materials which do not crack under sulphide stress.

13. The apparatus of claim 12, wherein the metal comprises a material selected from the group consisting of commercial steel, SA-516 70, 304L SS, 347 SS, 430 SS, Nickel, Hastelloy C276, C22 and X; and Alloy 20.

14. The apparatus of claim 1, wherein the corrosion resistant tube is formed from a metal selected from the group consisting of stainless steel, austenitic stainless steel, duplex stainless steel and super-duplex stainless steel.

15. The apparatus of claim 1, wherein the corrosion resistant portion of the tube comprises an interior surface and an exterior surface disposed within the sulphide treatment vessel, and wherein the interior surface and the exterior surface are corrosion resistant.

16. The apparatus of claim 1, wherein the tube comprises at least one layer of corrosion resistant material and the thickness of the corrosion resistant layer is 76 μm-102 μm DFT.

17. The apparatus of claim 8, further comprising means for coupling the process piping flange to the inlet nozzle flange.
